(19) United States
(12) Patent Application Publication
(10) Pub. No.: US 2026/0287915 A1
(43) Pub. Date: Sep. 24, 2026

(54) DEVICE FOR SEEING THROUGH AN OBSTACLE

(71) Applicant: Ting-Han HONG, Taoyuan City (TW)

(72) Inventor: Ting-Han HONG, Taoyuan City (TW)

(21) Appl. No.: 19/418,003

(22) Filed: Dec. 12, 2025

(30) Foreign Application Priority Data
Mar. 21, 2025 (TW) 114110712

(51) Int. Cl. G02B 27/28; B60R 1/10

(52) U.S. Cl. CPC G02B 27/28; B60R 1/10

(57) ABSTRACT

A device for seeing through an obstacle comprises a first composite polarizing film and a second composite polarizing film. The first composite polarizing film is disposed between a user and an obstacle, and comprises a first reflective polarizing layer and a first absorptive polarizing layer. The first reflective polarizing layer is configured to split target incident light into target reflected light and target transmitted light. It reflects the target reflected light and transmits the target transmitted light to the viewing position. The first absorptive polarizing layer is configured to split interference incident light into interference transmitted light and absorbed light. It transmits the interference transmitted light and absorbs the absorbed light. The second composite polarizing film is disposed between the first composite polarizing film and the obstacle, parallel to the first composite polarizing film, to reflect the target reflected light projected to the viewing position, and to absorb the interference transmitted light.

### BACKGROUND OF THE INVENTION

This application claims the benefit of Taiwan Patent Application Serial No. 114110712, filed on Mar. 21, 2025, the subject matter of which is incorporated herein by reference.

### (1) Field of the Invention

The invention relates to a device for seeing through, and more particularly to a device for seeing through an obstacle.

### (2) Description of the Prior Art

While a vehicle is in motion, the A-pillar often obstructs the view of pedestrians, potholes, or traffic signs, increasing the risk of traffic accidents. To solve the aforementioned problems, various solutions have been proposed in the prior art.

A common solution is to install cameras on the vehicle body facing the blind spot area (i.e., the area blocked by the A-pillar) and transmit real-time images to the vehicle to assist the driver in making judgments. However, the above solution has problems: First, the camera requires additional power from the vehicle, increasing the energy burden; second, there may be delays in image transmission, which may affect the driver's immediate judgment.

Another common solution is to install multi-faceted rearview mirror near the A-pillar, using the principle of optical reflection to project images of blind spot area into the driver's eyes. However, this solution also has problems: First, the reflected image may be distorted or misaligned, affecting the driver's judgment; second, the rearview mirror may reflect other lights inside the vehicle into the driver's eyes, making it impossible for the driver to accurately identify the situation behind the A-pillar.

### SUMMARY OF THE INVENTION

In view of the problems of image distortion, image misalignment, and reflection of excess lights into the driver's eyes in the prior art using rearview mirror. The main purpose of the present invention is to provide a device for seeing through an obstacle. A first composite polarizing film and a second composite polarizing film are respectively disposed between a user and the obstacle to project the target incident light behind the obstacle onto the user's viewing position and to absorb the interference incident light that affects the imaging, thereby solving the aforementioned problems.

Accordingly, the necessary technical means adopted by the present invention to solve the problems of prior arts is to provide a device for seeing through an obstacle, configured to display a blind spot image of a blind spot area when a user cannot see the blind spot image obstructed by the obstacle.

The device for seeing through an obstacle comprises a first composite polarizing film and a second composite polarizing film. The first composite polarizing film is disposed between the user and the obstacle, and is disposed adjacent to the obstacle, having a first side facing the blind spot area and a second side facing away from the blind spot area. The first composite polarizing film includes a first reflective polarizing layer and a first absorptive polarizing layer.

The first reflective polarizing layer is disposed adjacent to the first side. When a target incident light passes through the blind spot area and is projected onto the first side, the first reflective polarizing layer is configured to split the target incident light into a target reflected light and a target transmitted light with opposite polarization directions, then the target reflected light is reflected from the first side, and the target transmitted light is transmitted from the second side and projected onto a viewing position of the user.

The first absorptive polarizing layer is disposed adjacent to the second side. When an interference incident light which is away from the blind spot area is projected onto the second side, the first absorptive polarizing layer is configured to split the interference incident light into an interference transmitted light and an absorbed light with opposite polarization directions, then the interference transmitted light is transmitted from the first side, and the absorbed light is absorbed.

Preferably, the first composite polarizing film further includes a first transparent substrate, disposed adjacent to the first reflective polarizing layer or the first absorptive polarizing layer.

The second composite polarizing film is disposed between the first composite polarizing film and the obstacle, parallel to the first composite polarizing film. When the target reflected light is projected onto the second composite polarizing film, the second composite polarizing film is configured to reflect the target reflected light at the viewing position, and to absorb the interference transmitted light projected onto the second composite polarizing film, wherein when the target transmitted light and the target reflected light are projected onto the viewing position, they together form the blind spot image to been seen by the user.

Based on the aforementioned necessary technical means, the following auxiliary technical means can be derived. Preferably, the second composite polarizing film includes a second absorptive polarizing layer and a reflective layer. The second absorptive polarizing layer is disposed adjacent to the first side, configured to absorb the interference transmitted light. The reflective layer is disposed away from the first side, configured to reflect the target reflected light projected onto the viewing position.

As mentioned above, preferably, the second composite polarizing film further includes a second substrate, disposed adjacent to the second absorptive polarizing layer or the reflective layer.

As mentioned above, preferably, the angle between the transmission axis of the first reflective polarizing layer and the transmission axis of the first absorptive polarizing layer is less than 70 degrees, and the angle between the transmission axis of the first reflective polarizing layer and the transmission axis of the second absorptive polarizing layer is greater than 30 degrees.

Based on the aforementioned necessary technical means, the following auxiliary technical means can be derived. Preferably, the second composite polarizing film includes a second reflective polarizing layer and a light-absorbing layer. The second reflective polarizing layer is disposed adjacent to the first side, configured to reflect the target reflected light projected onto the viewing position. The light-absorbing layer is disposed away from the first side, configured to absorb the interference transmitted light.

As mentioned above, preferably, the second composite polarizing film further includes a second substrate, disposed adjacent to the second reflective polarizing layer or the light-absorbing layer.

As mentioned above, preferably, the angle between the transmission axis of the first reflective polarizing layer and the transmission axis of the first absorptive polarizing layer is less than 70 degrees, and the angle between the transmission axis of the first reflective polarizing layer and the transmission axis of the second reflective polarizing layer is less than 70 degrees.

To summarize, the present invention provides a device for seeing through an obstacle. A first composite polarizing film and a second composite polarizing film are respectively disposed between a user and the obstacle to project the target incident light behind the obstacle onto the user's viewing position and to absorb the interference incident light that affects the imaging, thereby solving the aforementioned problems.

The specific embodiments used in the present invention will be further explained through the following embodiments and drawings.

### BRIEF DESCRIPTION OF THE DRAWINGS

The present invention will now be specified with reference to its preferred embodiment illustrated in the drawings, in which:

FIG. 1 shows a top view of the device for seeing through an obstacle according to the first embodiment of the present invention;

FIG. 2 shows a perspective view of the device for seeing through an obstacle according to the first embodiment of the present invention;

FIG. 3 shows a schematic diagram of the light projection of the device for seeing through an obstacle according to the first embodiment of the present invention; and

FIG. 4 shows a schematic diagram of the light projection of the device for seeing through an obstacle according to the second embodiment of the present invention.

### DESCRIPTION OF THE PREFERRED EMBODIMENT

The invention disclosed herein is directed to a device for seeing through an obstacle. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

Since the device for seeing through an obstacle provided by the present invention has a variety of feasible structural options, they will not be described in detail here. Only two preferred embodiments are described for specific explanation, and these embodiments are only used to conveniently and clearly assist in explaining the purpose and effects of the present invention.

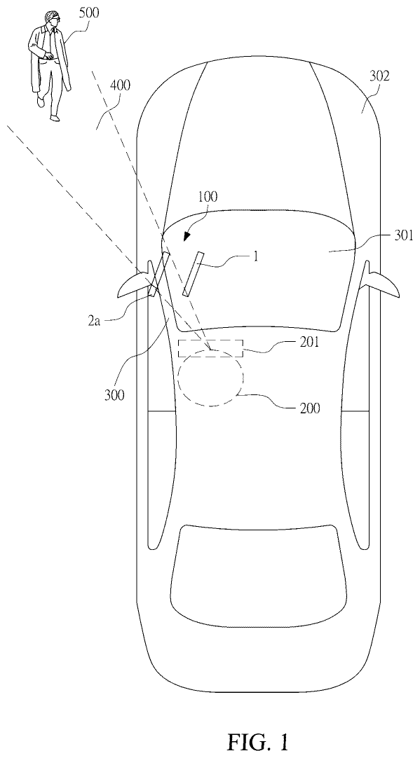

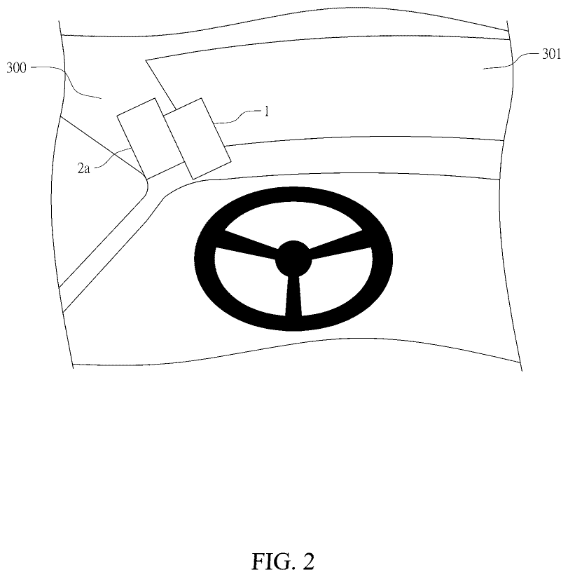

Referring to FIG. 1 and FIG. 2, FIG. 1 shows a top view of the device for seeing through an obstacle according to the first embodiment of the present invention; and FIG. 2 shows a perspective view of the device for seeing through an obstacle according to the first embodiment of the present invention. As shown in FIG. 1 and FIG. 2, a device 100 for seeing through an obstacle is configured to display a blind spot image of a blind spot area 400 when a user 200 cannot see the blind spot image obstructed by the obstacle 300.

In the present embodiment, the device 100 for seeing through an obstacle is installed in a vehicle 302 (or other means of transportation) having a windshield 301, that is, the user 200 is a driver, the obstacle 300 is an A-pillar, and the blind spot image is an image formed by the light reflected from a pedestrian 500 within the blind spot area 400. In fact, the blind spot image can also be images formed by the reflection of light from roadblocks, potholes, or traffic signs within the blind spot area.

In other embodiment, the device 100 for seeing through an obstacle can be used in other situations where it is necessary to present the blind spot images. For example, when the user 200 is a pedestrian, the obstacle 300 is a wall at the corner. Before turning, the user 200 can see the blind spot image in advance with the help of the device 100 for seeing through an obstacle, thereby avoiding potential collision risks.

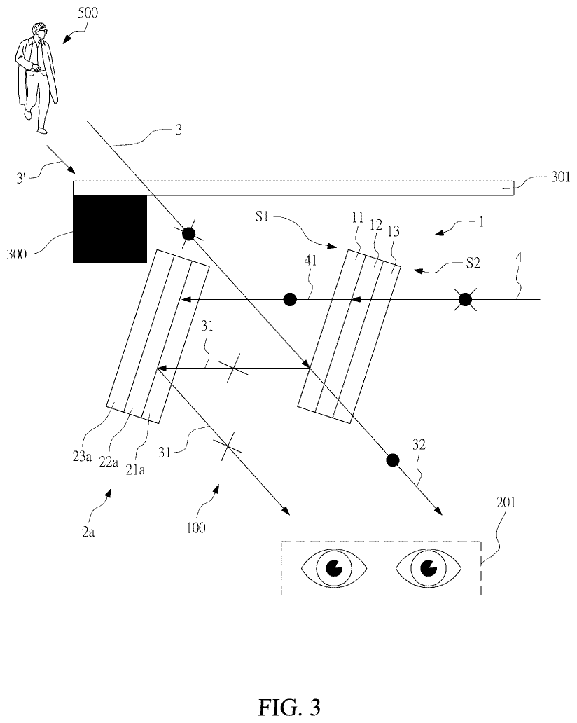

Referring to FIG. 3 now, FIG. 3 shows a schematic diagram of the light projection of the device for seeing through an obstacle according to the first embodiment of the present invention. Please refer to FIG. 1 and FIG. 2 together.

As shown in FIG. 3, the device 100 for seeing through an obstacle comprises a first composite polarizing film 1 and a second composite polarizing film 2. The first composite polarizing film 1 is disposed between the user 200 and the obstacle 300, and is disposed adjacent to the obstacle 300, having a first side S1 facing the blind spot area 400 and a second side S2 facing away from the blind spot area 400.

The first composite polarizing film 1 includes a first reflective polarizing layer 11 and a first absorptive polarizing layer 12. The first reflective polarizing layer 11 is disposed adjacent to the first side S1. When a target incident light 3 passes through the blind spot area 400 and is projected onto the first side S1, the first reflective polarizing layer 11 is configured to split the target incident light 3 into a target reflected light 31 and a target transmitted light 32 with opposite polarization directions, then the target reflected light 31 is reflected from the first side S1, and the target transmitted light 32 is transmitted from the second side S2 and projected onto a viewing position 201 of the user 200.

In the present embodiment, when the pedestrian 500 is illuminated by light (such as sunlight, vehicle headlights or ambient light), it will reflect the target incident light 3 and the target incident light 3′ blocked by the obstacle 300 towards the user 200. Since the user 200 and the pedestrian 500 are a certain distance apart, the target incident light 3 can be regarded as the target incident light 3′.

The first absorptive polarizing layer 12 is disposed adjacent to the second side S2. When an interference incident light 4 (such as stray lights inside the vehicle 302) which is away from the blind spot area 400 is projected onto the second side S2, the first absorptive polarizing layer 12 is configured to split the interference incident light 4 into an interference transmitted light 41 and an absorbed light with opposite polarization directions, then the interference transmitted light 41 is transmitted from the first side S1, and the absorbed light is absorbed.

In the present embodiment, the first composite polarizing film 1 further includes a first transparent substrate 13, disposed adjacent to the first absorptive polarizing layer 12, but is not limited thereto. In other embodiment, the first transparent substrate 13 can be disposed adjacent to the first reflective polarizing layer 11. As mentioned above, the first transparent substrate 13 may be made of glass, acrylic or polycarbonate (PC).

The second composite polarizing film 2a is disposed between the first composite polarizing film 1 and the obstacle 300, parallel to the first composite polarizing film 1. In the present invention, ideally, it's better that they are perfectly parallel (without any angular deviation). However, considering factors such as assembly tolerances and field of view adjustments, a certain degree of angular deviation is allowed (e.g., a deviation of less than 5 degrees), and it is still considered as a parallel setting.

When the target reflected light 31 is projected onto the second composite polarizing film 2a, the second composite polarizing film 2a is configured to reflect the target reflected light 31 at the viewing position 201, and to absorb the interference transmitted light 41 projected onto the second composite polarizing film 2a.

In the present embodiment, the second composite polarizing film 2a includes a second absorptive polarizing layer 21a, a reflective layer 22a, and a second substrate 23a. The second absorptive polarizing layer 21a is disposed adjacent to the first side S1, configured to absorb the interference transmitted light 41. The reflective layer 22a is disposed away from the first side S1, configured to reflect the target reflected light 31 projected onto the viewing position 201. In the present embodiment, the reflective layer 22a is made by coating a metal or dielectric material that can reflect light, such as silver (Ag), aluminum (Al), chromium (Cr), titanium (Ti), nickel (Ni), copper (Cu), gold (Au), molybdenum (Mo), or a multilayer dielectric.

In the present embodiment, the second substrate 23a is disposed adjacent to the reflective layer 22a (from left to right, the layers are: the second substrate 23a, the reflective layer 22a, and the second absorptive polarizing layer 21a). In other embodiment, the second substrate 23a can be disposed adjacent to the second absorptive polarizing layer 21a (from left to right, the layers are: the reflective layer 22a, the second absorptive polarizing layer 21a, and the second substrate 23a) or disposed between the reflective layer 22a and the second absorptive polarizing layer 21a (from left to right, the layers are: the reflective layer 22a, the second substrate 23a, and the second absorptive polarizing layer 21a).

As mentioned above, in the embodiment where the second substrate 23a is disposed adjacent to the reflective layer 22a, the second substrate 23a can be made of glass, acrylic, polycarbonate (PC), various plastics, various types of wood or metal. In the embodiment where the second substrate 23a is disposed adjacent to the second absorptive polarizing layer 21a, the second substrate 23a needs to be transparent to allow light to pass through, and can be made of glass, acrylic, polycarbonate (PC) or various plastics. In the embodiment where the second substrate 23a is disposed between the reflective layer 22a and the second absorptive polarizing layer 21a, the second substrate 23a also needs to be transparent to allow light to pass through, and can be made of glass, acrylic, polycarbonate (PC) or various plastics.

In the present embodiment, the aforementioned polarizing layers are all polarizing films and can be attached to a transparent substrate. Reflective polarizing films can be cholesterol liquid crystal films, multilayer birefringent films, or wire-grid polarizing films, used to reflect lights that cannot penetrate. Absorptive polarizing films are used to absorb lights that cannot penetrate. The structure of the polarizing film is the prior art and will not be described again in the present embodiment.

In other embodiment, alternatively, the reflective layer 22a can be used directly as a substrate (that is, the second composite polarizing film 2a does not include the second substrate 23a). In this case, the reflective layer 22a can be made by directly polishing metal.

In the first embodiment, the angle between the transmission axis of the first reflective polarizing layer 11 and the transmission axis of the first absorptive polarizing layer 12 is less than 70 degrees, and the angle between the transmission axis of the first reflective polarizing layer 11 and the transmission axis of the second absorptive polarizing layer 21a is greater than 30 degrees. When the angle between the transmission axis of the first reflective polarizing layer 11 and the transmission axis of the first absorptive polarizing layer 12 is 0 degrees (i.e. they are parallel to each other), and the angle between the transmission axis of the first reflective polarizing layer 11 and the transmission axis of the second absorptive polarizing layer 21 a is 90 degrees (i.e. they are perpendicular to each other), better optical quality is obtained.

When the target reflected light 31 and the target transmitted light 32 are projected onto the viewing position 201, they together form the blind spot image to been seen by the user 200. Furthermore, since the interference transmitted light 41 is absorbed, it will not affect the imaging quality of the blind spot image.

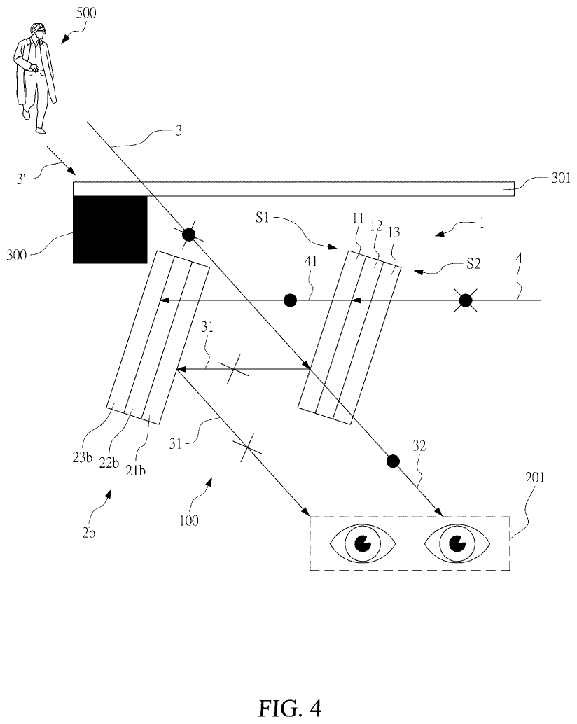

Referring to FIG. 4, FIG. 4 shows a schematic diagram of the light projection of the device for seeing through an obstacle according to the second embodiment of the present invention. Please refer to FIG. 1 to FIG. 3 together. As shown in FIG. 4, the difference between the second embodiment and the first embodiment is in the structure of the second composite polarizing film 2b. The others are similar to or the same as the first embodiment. Please refer to the description in the corresponding paragraph. In the present embodiment, the second composite polarizing film 2b includes a second reflective polarizing layer 21b, a light-absorbing layer 22b, and a second substrate 23b.

The second reflective polarizing layer 21b is disposed adjacent to the first side S1, configured to reflect the target reflected light 31 projected onto the viewing position 201. The light-absorbing layer 22b is disposed away from the first side S1, configured to absorb the interference transmitted light 41. In the present embodiment, the light-absorbing layer 22b is made of dark light-absorbing materials such as ink, pigment, dye or metal oxide film.

In the present embodiment, the second substrate 23b is disposed adjacent to the light-absorbing layer 22b (from left to right, the layers are: the second substrate 23a, the light-absorbing layer 22b, and the second absorptive polarizing layer 21b), but is not limited thereto. In other embodiment, the second substrate 23b can be disposed adjacent to the second absorptive polarizing layer 21b (from left to right, the layers are: the light-absorbing layer 22b, the second absorptive polarizing layer 21b, and the second substrate 23b) or disposed between the light-absorbing layer 22b and the second absorptive polarizing layer 21b (from left to right, the layers are: the light-absorbing layer 22b, the second substrate 23b, and the second absorptive polarizing layer 21b).

As mentioned above, in the embodiment where the second substrate 23b is disposed adjacent to the light-absorbing layer 22b, the second substrate 23b can be made of glass, acrylic, polycarbonate (PC), various plastics, various types of wood or metal. In the embodiment where the second substrate 23b is disposed adjacent to the second absorptive polarizing layer 21b, the second substrate 23b needs to be transparent to allow light to pass through, and can be made of glass, acrylic, polycarbonate (PC) or various plastics. In the embodiment where the second substrate 23b is disposed between the light-absorbing layer 22b and the second absorptive polarizing layer 21b, the second substrate 23b can allow some or all of the light to pass through, and can be made of glass, colored glass, acrylic, colored acrylic, polycarbonate (PC), various plastics, or haze substrates (such as diffusers).

Others, in other embodiment, alternatively, the light-absorbing layer 22b can be used directly as a substrate (that is, the second composite polarizing film 2b does not include the second substrate 23b). In this case, the light-absorbing layer 22b can be, for example, a dark light-absorbing acrylic sheet, dark glass, or a dark light-absorbing plastic sheet.

In the second embodiment, the angle between the transmission axis of the first reflective polarizing layer 11 and the transmission axis of the first absorptive polarizing layer 12 is less than 70 degrees, and the angle between the transmission axis of the first reflective polarizing layer 11 and the transmission axis of the second reflective polarizing layer 21b is less than 70 degrees. When the angle between the transmission axis of the first reflective polarizing layer 11 and the transmission axis of the first absorptive polarizing layer 12 is 0 degrees (i.e. they are parallel to each other), and the angle between the transmission axis of the first reflective polarizing layer 11 and the transmission axis of the second absorptive polarizing layer 21b is also 0 degrees (i.e. they are parallel to each other), better optical quality is obtained.

Similar to the first embodiment, when the target reflected light 31 and the target transmitted light 32 are projected onto the viewing position 201, they together form the blind spot image to been seen by the user 200. Furthermore, since the interference transmitted light 41 is absorbed, it will not affect the imaging quality of the blind spot image.

To summarize, the device 100 for seeing through an obstacle provided by the present invention provides a first composite polarizing film 1 and a second composite polarizing film 2a (or a second composite polarizing film 2b) between the user 200 and the obstacle 300, so as to project the target incident light 3 behind the obstacle 300 onto the viewing position 201 of the user 200, and to absorb the interference incident light 4 that affects the imaging, thereby solving the aforementioned problems.

While the present invention has been particularly shown and described with reference to a preferred embodiment, it will be understood by those skilled in the art that various changes in form and detail may be without departing from the spirit and scope of the present invention.

What is claimed is:

1. A device for seeing through an obstacle, configured to display a blind spot image of a blind spot area when a user cannot see the blind spot image obstructed by the obstacle, the device comprising:
a first composite polarizing film, disposed between the user and the obstacle and disposed adjacent to the obstacle, having a first side facing the blind spot area and a second side facing away from the blind spot area, which includes:
a first reflective polarizing layer, disposed adjacent to the first side, wherein when a target incident light passes through the blind spot area and is projected onto the first side, the first reflective polarizing layer is configured to split the target incident light into a target reflected light and a target transmitted light with opposite polarization directions, then the target reflected light is reflected from the first side, and the target transmitted light is transmitted from the second side and projected onto a viewing position of the user; and
a first absorptive polarizing layer, disposed adjacent to the second side, wherein when an interference incident light which is away from the blind spot area is projected onto the second side, the first absorptive polarizing layer is configured to split the interference incident light into an interference transmitted light and an absorbed light with opposite polarization directions, then the interference transmitted light is transmitted from the first side, and the absorbed light is absorbed; and
a second composite polarizing film, disposed between the first composite polarizing film and the obstacle, parallel to the first composite polarizing film, wherein when the target reflected light is projected onto the second composite polarizing film, the second composite polarizing film is configured to reflect the target reflected light at the viewing position, and to absorb the interference transmitted light projected onto the second composite polarizing film,
wherein when the target transmitted light and the target reflected light are projected onto the viewing position, they together form the blind spot image to been seen by the user.

2. The device of claim 1, wherein the first composite polarizing film further includes a first transparent substrate, disposed adjacent to the first reflective polarizing layer or the first absorptive polarizing layer.

3. The device of claim 1, wherein the second composite polarizing film includes:
a second absorptive polarizing layer, disposed adjacent to the first side, configured to absorb the interference transmitted light; and
a reflective layer, disposed away from the first side, configured to reflect the target reflected light projected onto the viewing position.

4. The device of claim 3, wherein the second composite polarizing film further includes a second substrate, disposed adjacent to the second absorptive polarizing layer or the reflective layer.

5. The device of claim 3, wherein the angle between the transmission axis of the first reflective polarizing layer and the transmission axis of the first absorptive polarizing layer is less than 70 degrees, and the angle between the transmission axis of the first reflective polarizing layer and the transmission axis of the second absorptive polarizing layer is greater than 30 degrees.

6. The device of claim 1, wherein the second composite polarizing film includes:
a second reflective polarizing layer, disposed adjacent to the first side, configured to reflect the target reflected light projected onto the viewing position; and
a light-absorbing layer, disposed away from the first side, configured to absorb the interference transmitted light.

7. The device of claim 6, wherein the second composite polarizing film further includes a second substrate, disposed adjacent to the second reflective polarizing layer or the light-absorbing layer.

8. The device of claim 6, wherein the angle between the transmission axis of the first reflective polarizing layer and the transmission axis of the first absorptive polarizing layer is less than 70 degrees, and the angle between the transmission axis of the first reflective polarizing layer and the transmission axis of the second reflective polarizing layer is less than 70 degrees.
